(19) United States
(12) Patent Application Publication
(10) Pub. No.: US 2011/0230292 A1
(43) Pub. Date: Sep. 22, 2011

(54) VEHICLE DRIVE APPARATUS

(75) Inventors: Takuya KOMATSU, Anjo (JP); Natsuki SADA, Anjo (JP); Tomoo ATARASHI, Kariya (JP)

(73) Assignee: AISIN AW CO., LTD., Anjo-shi (JP)

(21) Appl. No.: 13/018,916

(22) Filed: Feb. 1, 2011

(30) Foreign Application Priority Data
Mar. 16, 2010 (JP) 2010-059181
Jul. 27, 2010 (JP) 2010-168253

(51) Int. Cl. B60K 6/365; F16H 3/44; F16H 57/04

(52) U.S. Cl. 475/5; 180/65.22; 903/902

(57) ABSTRACT

A vehicle drive apparatus comprising a planetary gear mechanism having a ring gear drive-coupled to one of an output member drive-coupled to wheels and a rotary electrical machine, a sun gear drive-coupled to the other of the output member and the rotary electrical machine, and a carrier drive-coupled to an engine and rotatably supporting a plurality of pinion gears, the apparatus. The vehicle drive apparatus having an outward receiver comprising a receiving portion opening outward in an apparatus radial direction and being provided on the carrier, the apparatus radial direction being a radial direction of the ring gear; a fluid supply part supplying lubricating fluid to an opening of the receiving portion of the outward receiver; and a bearing lubricating passage which is a route of lubricating fluid connecting the receiving portion of the outward receiver with a pinion bearing of each of the pinion gears.

### INCORPORATION BY REFERENCE

The disclosure of Japanese Patent Application No. 2010-168253 filed on Jul. 27, 2010 and Japanese Patent Application No. 2010-059181 filed on Mar. 16, 2010 including the specification, drawings and abstract is incorporated herein by reference in its entirety.

### BACKGROUND OF THE INVENTION

The present invention relates to a vehicle drive apparatus including a planetary gear mechanism having a ring gear drive-coupled to one of an output member drive-coupled to wheels and a rotary electrical machine, a sun gear drive-coupled to the other of the output member and the rotary electrical machine, and a carrier drive-coupled to an engine and rotatably supporting a plurality of pinion gears.

### DESCRIPTION OF THE RELATED ART

Conventionally, hybrid vehicles having a rotary electrical machine and an engine are used. In recent years, plug-in hybrid vehicles (hereinafter called “hybrid vehicles” unless it is particularly necessary to distinguish the plug-in hybrid vehicles from conventional “hybrid vehicles”) are brought into practice, which are capable of performing EV-traveling for a longer time than conventional hybrid vehicles. As such hybrid vehicles, there are split-type hybrid vehicles including a planetary gear mechanism for distributing motive power, which transmits torque transmitted from an engine to a rotary electrical machine and a distribution output member in a distributed manner. When the planetary gear mechanism is used for a split-type hybrid vehicle, for example, an output member coupled to wheels is drive-coupled to a ring gear, a rotor shaft of the rotary electrical machine is drive-coupled to a sun gear, and an output shaft of the engine is drive-coupled to a carrier. Pinion gears are provided between the ring gear and the sun gear. The number of teeth of each pinion gear is small compared to that of the ring gear and the sun gear, and thus the pinion gears often rotate at a high speed depending on rotation of the ring gear and the sun gear. Accordingly, lubricating fluid is supplied to pinion bearings provided inside in a radial direction of the pinion gears. For lubricating such pinion bearings, there is a technique described in Japanese Patent Application Publication No. H10-267114 listed below.

A lubricating device for a planetary gear described in Japanese Patent Application Publication No. H10-267114 is structured to include a main oil passage provided inside in a radial direction of an input shaft drive-coupled to a crank shaft of an engine, and an oil passage communicating from this main oil passage with an outer peripheral face of the input shaft. Further, a pump is drive-coupled to the input shaft, where a motive power source of the pump is rotary motive power of the input shaft. Lubricating fluid is supplied by this pump to the above-described main oil passage. The lubricating fluid supplied to the main oil passage is discharged by a centrifugal force via the oil passage to an outside in the radial direction of the input shaft. In the lubricating device of Japanese Patent Application Publication No. H10-267114, an oil receiver opening inward in the radial direction is provided on an end face in an axial direction of the carrier, so as to collect the lubricating fluid discharged in this manner and supply the lubricating fluid to an oil hole formed in a pinion shaft.

### SUMMARY OF THE INVENTION

The planetary gear mechanism described in Japanese Patent Application Publication No. H10-267114 is supplied with the lubricating fluid by the pump operated by rotation of the engine, as described above. On the other hand, it is possible that the split-type hybrid vehicle travels with only the rotary electrical machine (what is called EV-traveling) or is towed by another vehicle (towed traveling). In such cases, the engine of the split-type hybrid vehicle is in a stopped state, and thus the pump is stopped. Accordingly, during EV-traveling or towed traveling, supply of the lubricating fluid to the planetary gear mechanism is stopped. Also, during EV-traveling or towed traveling, the carrier drive-coupled to the engine does not rotate, but the ring gear drive-coupled to the output member and the sun gear drive-coupled to the rotary electrical machine rotate. So, the pinion gears and the pinion bearings rotate at a high speed in a state that no lubricating fluid is supplied. Thus, when the EV-traveling is performed continuously for a long time like in the plug-in hybrid vehicle, the lubrication becomes insufficient.

It is also conceivable that the lubricating fluid is supplied to the planetary gear mechanism using an electric pump or the like capable of operating during EV-traveling or towed traveling of the split-type hybrid vehicle. As described above, in the technique described in Japanese Patent Application Publication No. H10-267114, the oil receiver opening inward in the radial direction is provided to collect the lubricating fluid discharged from the input shaft. Accordingly, in a part of the oil receiver that is located higher than the input shaft, it is not possible to retain the collected lubricating fluid. Thus, when the electric pump or the like is used for the technique described in Japanese Patent Application Publication No. 1410-267114, the amount of lubricating fluid that can be supplied to a pinion gear and a pinion bearing located higher than the input shaft becomes smaller than the amount of lubricating fluid that can be supplied to a pinion gear and a pinion bearing located lower than the input shaft. Thus, supply of the lubricating fluid to some of the pinion gears and pinion bearings may be insufficient.

Accordingly, achievement of a vehicle drive apparatus capable of supplying the lubricating fluid to pinion bearings even when the engine is in a stopped state is desired.

A vehicle drive apparatus according to the present invention has a characteristic structure including a planetary gear mechanism having a ring gear drive-coupled to one of an output member drive-coupled to wheels and a rotary electrical machine, a sun gear drive-coupled to the other of the output member and the rotary electrical machine, and a carrier drive-coupled to an engine and rotatably supporting a plurality of pinion gears, and including an outward receiver including a receiving portion opening outward in an apparatus radial direction and being provided on the carrier, the apparatus radial direction being a radial direction of the ring gear, a fluid supply part supplying lubricating fluid to an opening of the receiving portion of the outward receiver, and a bearing lubricating passage which is a route of lubricating fluid connecting the receiving portion of the outward receiver with a pinion bearing of each of the pinion gears.

Here, being “drive-coupled” refers to a state that two rotation elements are coupled to be capable of transmitting a driving force, and is used as a concept including a state that the two rotation elements are coupled to rotate integrally or a state that the two rotation elements are coupled to be capable of transmitting a driving force via one or more transmission members. Such transmission members include various types of members which transmit rotation at the same speed or after shifting the speed thereof, and include, for example, a shaft, a gear mechanism, a belt, a chain, and the like. However, when being “drive-coupled” is used for each rotation element of the planetary gear mechanism, this refers to a state that the three rotation elements which the planetary gear mechanism includes are drive-coupled with each other without intervention of any other rotation element.

Further, “rotary electrical machine” is used as a concept including any one of a motor (electric motor), a generator (electric generator), and a motor-generator functioning both as a motor and a generator as necessary.

In such a characteristic structure, since the opening of the receiving portion of the outward receiver is provided to open outward in the apparatus radial direction of the ring gear, and the receiving portion having the opening and the pinion bearing of each of the pinion gears are provided to be coupled by the bearing lubricating passage, the lubricating fluid from the fluid supply part can be supplied to the pinion bearing. Accordingly, it is possible to supply the lubricating fluid to the pinion bearings regardless of the operating states of the rotary electrical machine and the engine which are drive-coupled to the planetary gear mechanism. Therefore, even when the engine is in a stopped state for example, the pinion bearings can be lubricated properly.

Preferably, the outward receiver is provided so that the opening does not overlap with the ring gear in an apparatus axial direction, the apparatus axial direction being an axial direction of the ring gear, and the fluid supply part is provided to supply the lubricating fluid toward the opening of the outward receiver.

In the present application, “overlap” in a certain direction regarding arrangement of two members means that the two members have, at least partially, portions at the same position with respect to arrangement in such a direction.

In such a structure, the opening of the outward receiver will not be blocked by the ring gear, and thus the fluid supply part can be provided more outside in the apparatus radial direction than the ring gear. Therefore, a supply route of lubricating fluid to the fluid supply part can be provided outside in the apparatus radial direction of the planetary gear mechanism, and thus the supply route of lubricating fluid can be formed with a simple structure.

Preferably, the fluid supply part supplies lubricating fluid picked up by a gear mechanism drive-coupled to the planetary gear mechanism to the outward receiver.

In such a structure, for example, the lubricating fluid used for lubricating a gear mechanism drive-coupled to the planetary gear mechanism can be re-used for lubricating the pinion bearings. Accordingly, it is not necessary to have a pump or the like for feeding the lubricating fluid to the fluid supply part, and hence it is possible to supply the lubricating fluid to the pinion bearings without increasing energy consumption required for driving the pump or the like. Thus, lubrication of the pinion bearings can be performed properly in a manner of saving energy.

Preferably, the fluid supply part has a fluid retaining portion retaining the lubricating fluid picked up by the gear mechanism, and a fluid dropping port communicating with the fluid retaining portion and dropping the lubricating fluid from a position overlapping with the opening of the outward receiver in an apparatus axial direction, the apparatus axial direction being an axial direction of the ring gear.

In such a structure, the lubricating fluid picked up by the gear mechanism may be supplied to the opening of the outward receiver by dropping the lubricating fluid. Accordingly, it is not necessary to provide a dedicated lubricating fluid supply passage for supplying the lubricating fluid to the pinion bearings, and hence the vehicle drive apparatus can be formed in compact size with light weight. It is also not necessary to have a pump or the like for feeding the lubricating fluid to the fluid retaining portion, and hence it is possible to supply the lubricating fluid to the pinion bearings without increasing energy consumption required for driving the pump or the like. Therefore, lubrication of the pinion bearings can be performed properly in a manner of saving energy.

Preferably, the fluid supply part includes internal teeth of the ring gear overlapping with the opening of the outward receiver in an apparatus axial direction, the apparatus axial direction being an axial direction of the ring gear.

In such a structure, the lubricating fluid can be picked up by the internal teeth of the ring gear according to rotation of the ring gear, and the picked up lubricating fluid can be supplied to the opening of the outward receiver directly. Accordingly, it is not necessary to provide a dedicated lubricating fluid supply passage for supplying the lubricating fluid to the pinion bearings, and hence the vehicle drive apparatus can be formed in compact size with light weight.

Preferably, the outward receiver includes an attaching portion attached to an end face in an apparatus axial direction of the carrier, the apparatus axial direction being an axial direction of the ring gear, and an extending portion provided to extend in an apparatus circumferential direction coaxially with the carrier, the apparatus circumferential direction being a circumferential direction of the ring gear, and extend outward in the apparatus radial direction from the attaching portion and toward a side to depart from the carrier in the apparatus axial direction, and the receiving portion is formed of the extending portion and the end face in the apparatus axial direction of the carrier, and the opening is formed between an edge located outside in the apparatus radial direction of the extending portion and the end face in the apparatus axial direction of the carrier.

In such a structure, since the outward receiver is provided to extend in the apparatus circumferential direction coaxially with the carrier, it is possible to supply the lubricating fluid to the pinion bearings across the apparatus circumferential direction regardless of the position in a rotational direction of the pinion gears. Therefore, lubrication of the pinion bearings can be performed constantly.

Preferably, the outward receiver includes an outer peripheral groove as the receiving portion provided in an outer peripheral face of the carrier and opening outward in the apparatus radial direction, and a communication hole communicating the outer peripheral groove with the bearing lubricating passage.

In such a structure, the lubricating fluid from the fluid supply part can be collected in the outer peripheral groove, and the collected lubricating fluid can be supplied to the bearing lubricating passage via the communication hole. Accordingly, it is possible to supply the lubricating fluid to the pinion bearings regardless of the operating states of the rotary electrical machine and the engine which are drive-coupled to the planetary gear mechanism. Therefore, even when the engine is in a stopped state for example, the pinion bearings can be lubricated properly.

Preferably, the outward receiver is provided on one end face in an apparatus axial direction of the carrier, the apparatus axial direction being an axial direction of the ring gear, the vehicle drive apparatus includes an inward receiver including a receiving portion opening inward in the apparatus radial direction and being provided on another end face in the apparatus axial direction of the carrier, and an inside fluid supply part supplying lubricating fluid to an opening of the receiving portion of the inward receiver, and the bearing lubricating passage also has a route of lubricating fluid connecting the receiving portion of the inward receiver with a pinion bearing of each of the pinion gears.

In such a structure, the lubricating fluid can be supplied to the opening of the receiving portion of the inward receiver from an inside in the apparatus radial direction. Since the receiving portion is connected with the pinion bearing, it is possible to supply the lubricating fluid supplied from the inside in the apparatus radial direction to the pinion bearing.

Preferably, the carrier includes a pinion shaft supporting each of the pinion gears via the pinion bearing, the bearing lubricating passage is structured to have a fluid through passage passing through the pinion shaft in an axial direction, and a fluid communication passage communicating the fluid through passage with the pinion bearing provided on an outer peripheral face of the pinion shaft, and one end in the apparatus axial direction of the fluid through passage communicates with the receiving portion of the outward receiver, and another end in the apparatus axial direction of the fluid through passage communicates with the receiving portion of the inward receiver.

In such a structure, the receiving portion of the outward receiver and the receiving portion of the inward receiver can be in a communication state via the fluid through passage. Accordingly, the lubricating fluid which has flowed to the receiving portion of the inward receiver from the receiving portion of the outward receiver can be allowed to run down the inward receiver and flow downward, and to thereby flow to the fluid through passage located therebelow. Therefore, the lubricating fluid can be re-used for lubricating the pinion bearings without discharging the lubricating fluid to an outside in the apparatus axial direction of the planetary gear mechanism, and hence it is possible to lubricate the pinion bearings efficiently.

Preferably, the vehicle drive apparatus includes a pump driven by the engine drive-coupled to the carrier to supply lubricating fluid to the inside fluid supply part.

In such a structure, it is possible to supply the lubricating fluid to the opening of the receiving portion of the inward receiver by using motive power of the engine. On the other hand, as described above, the lubricating fluid is supplied to the opening of the receiving portion of the outward receiver irrespective of rotation of the engine. Accordingly, while the engine is rotating, the lubricating fluid can be supplied to the bearing lubricating passage from both the outside in the apparatus radial direction and the inside in the apparatus radial direction. While the engine is stopped, the lubricating fluid can be supplied to the bearing lubricating passage from the outside in the apparatus radial direction. Therefore, it is possible to lubricate the pinion bearings properly irrespective of the operating state of the engine.

### BRIEF DESCRIPTION OF THE DRAWINGS

FIG. 1 is a skeleton diagram of a vehicle drive apparatus;

FIG. 2 is a cross-sectional view of a substantial part of the vehicle drive apparatus according to a first embodiment;

FIG. 3 is a cross-sectional view of a substantial part of the vehicle drive apparatus according to a second embodiment;

FIG. 4 is a cross-sectional view taken along an outer peripheral groove of a carrier according to the second embodiment;

FIG. 5 is a cross-sectional view of a substantial part of the vehicle drive apparatus according to a third embodiment; and

FIG. 6 is a cross-sectional view of a substantial part of the vehicle drive apparatus according to a fourth embodiment.

### DETAILED DESCRIPTION OF THE EMBODIMENTS

1. First Embodiment

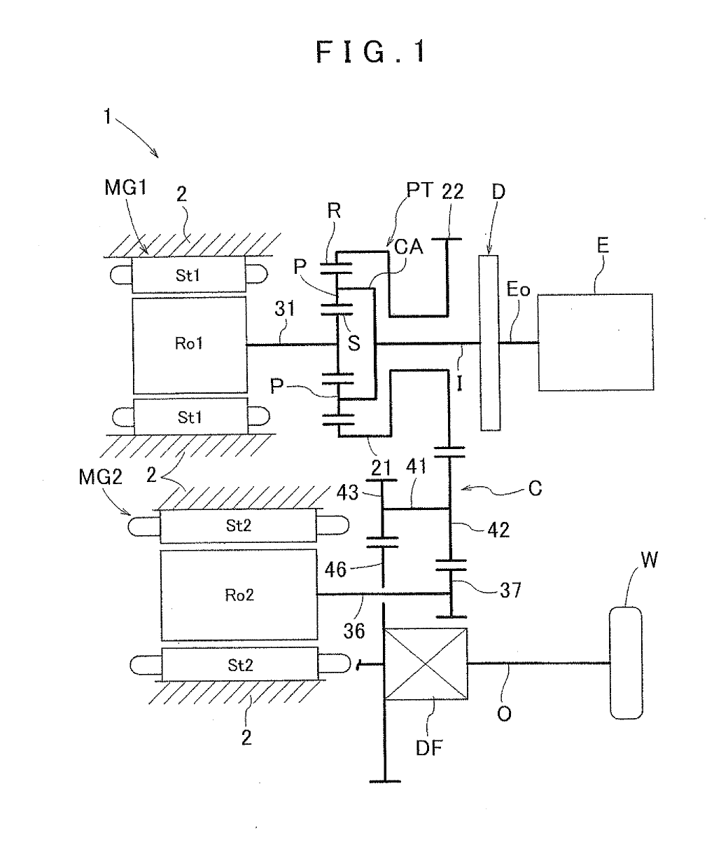

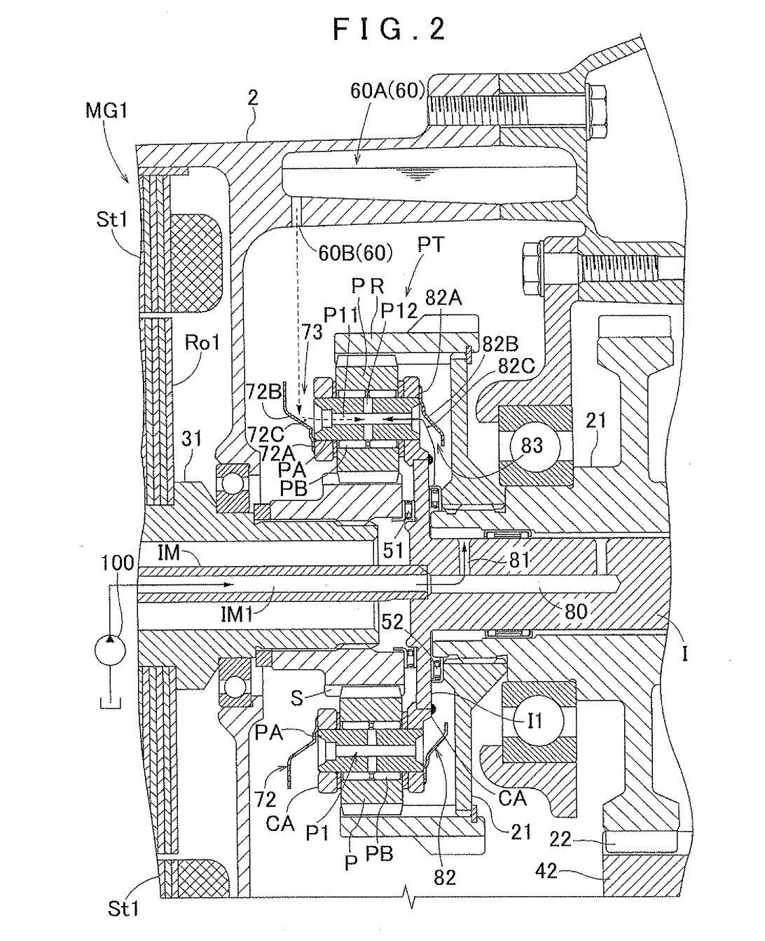

A vehicle drive apparatus 1 according to the present invention is structured to be capable of supplying a lubricating fluid to pinion bearings which a planetary gear mechanism PT includes even when a pump driven by an engine is in a stopped state. Hereinafter, such a vehicle drive apparatus 1 will be described with reference to the drawings. FIG. 1 illustrates a skeleton diagram of the vehicle drive apparatus 1 according to this embodiment, and FIG. 2 illustrates a cross-sectional view of a substantial part of the vehicle drive apparatus 1 according to this embodiment.

The vehicle drive apparatus 1 is a drive apparatus for a hybrid vehicle capable of traveling using both an engine E and two rotary electrical machines MG1, MG2 as driving force sources, and is particularly suitable for a plug-in hybrid vehicle which stops the engine E and travels for a long time using the rotary electrical machine MG2 as a motive power source. The vehicle drive apparatus 1 according to this embodiment is a hybrid drive apparatus for a front engine front drive (FF) vehicle, the apparatus being disposed adjacent in a vehicle width direction to the engine E that is laterally installed in the vehicle, and structured to be coupled to an output shaft Eo of the engine E in an axial direction.

Such a vehicle drive apparatus 1 is structured as a hybrid drive apparatus of what is called two-motor split type (split system). The vehicle drive apparatus 1 includes an input shaft I drive-coupled to the engine E, the first rotary electrical machine MG1 having a first rotor Ro1, the planetary gear mechanism PT for distributing motive power, which transmits torque transmitted from the engine E to the first rotary electrical machine MG1 and a distribution output member 21 in a distributed manner, and an output gear 22 provided to be capable of outputting torque transmitted to the distribution output member 21 to the side of vehicle wheels W. Further, the second rotary electrical machine MG2 is drive-coupled to the distribution output member 21 and the output gear 22 via a counter gear mechanism C.

The planetary gear mechanism PT is structured to have a ring gear R, a sun gear S, and a carrier CA. In this embodiment, the ring gear R is drive-coupled to the distribution output member as an output member drive-coupled to the wheels W. The sun gear S is drive-coupled to the first rotary electrical machine MG1. The carrier CA is drive-coupled to the engine E and rotatably supports a plurality of pinion gears P. In such a structure, the vehicle drive apparatus 1 according to this embodiment is structured to be capable of supplying the lubricating fluid to pinion bearings PB (see FIG. 2) even when the engine E is stopped.

1-1. Overall Structure of the Vehicle Drive Apparatus

First, an overall structure of the vehicle drive apparatus 1 according to this embodiment will be described. As illustrated in FIG. 1, an input shaft I is drive-coupled to the engine E. Here, the engine E is an internal combustion engine driven by combustion of fuel, for which one of various types of publicly known engines such as gasoline engines and diesel engines for example can be used. In this example, the input shaft I is drive-coupled to the engine output shaft Ea such as a crank shaft of the engine E via a damper D.

The first rotary electrical machine MG1 has a first stator St1 fixed to a case 2 and a first rotor Ro1 supported rotatably inside in a radial direction of the first stator St1. The first rotor Ro1 is drive-coupled to the sun gear S of the planetary gear mechanism PT so as to integrally rotate therewith. Accordingly, the first rotary electrical machine MG1 is disposed coaxially with the planetary gear mechanism PT. The first rotary electrical machine MG1 is capable of functioning as a motor (electric motor) generating motive power while receiving supply of electric power and functioning as a generator (power generator) generating electric power while receiving supply of motive power. Thus, the first rotary electrical machine MG1 is connected electrically to a not-illustrated power storage. In this example, a battery is used as the power storage. It is also preferred that a capacitor or the like be used as the power storage. In this example, the first rotary electrical machine MG1 mainly functions as a generator which generates electric power from torque of the input shaft I (engine E) inputted via the planetary gear mechanism PT, and charges the battery or supplies electric power to drive the second rotary electrical machine MG2. However, while the vehicle is traveling at a high speed, when the engine E is started, or the like, the first rotary electrical machine MG1 may also function as a motor which is powered to output a driving force. In this embodiment, the first rotary electrical machine MG1 corresponds to a “rotary electrical machine” according to the present invention.

The second rotary electrical machine MG2 has a second stator St2 fixed to the case 2 and a second rotor Ro2 supported rotatably inside in a radial direction of the second stator St2. The second rotor Ro2 is drive-coupled to a second rotor shaft 36 and a second rotary electrical machine output gear 37 so as to integrally rotate therewith. The second rotary electrical machine MG2 is capable of functioning as a motor (electric motor) generating motive power while receiving supply of electric power and functioning as a generator (power generator) generating electric power while receiving supply of motive power. Thus, the second rotary electrical machine MG2 also is connected electrically to the battery as the power storage. In this example, the second rotary electrical machine MG2 mainly functions as a motor which supplements the driving force to make the vehicle travel. However, while the vehicle is decelerating, or the like, the second rotary electrical machine MG2 may also function as a generator which generates electrical energy from an inertial force of the vehicle.

In this embodiment, the planetary gear mechanism PT is a single-pinion type planetary gear mechanism disposed coaxially with the input shaft I. Specifically, the planetary gear mechanism PT has three rotation elements: the carrier CA supporting the plurality of pinion gears P, and the sun gear S and the ring gear R each meshing with the pinion gears P. The sun gear S is drive-coupled to a first rotor shaft 31 of the first rotor Ro1 of the first rotary electrical machine MG1 so as to integrally rotate therewith. The carrier CA is drive-coupled to the input shaft I so as to integrally rotate therewith. The ring gear R is drive-coupled to the distribution output member 21 to integrally rotate therewith. The order of the three rotation elements that the planetary gear mechanism PT has is the sun gear S, the carrier CA, and the ring gear R in the order of rotation speeds. The order of rotation speeds is either from a high speed side to a low speed side or from the low speed side to the high speed side, and may take either side depending on the rotation state of the planetary gear mechanism PT. However, the order of the rotation elements would not change in either case.

The planetary gear mechanism. PT transmits torque of the engine E, which is transmitted to the input shaft I, to the first rotary electrical machine MG1 and the distribution output member 21 in a distributed manner. In the planetary gear mechanism PT, the input shaft I is drive-coupled to the carrier CA which is in the middle of the aforementioned order of rotation speeds. The first rotor Ro1 of the first rotary electrical machine MG1 is drive-coupled to the sun gear S, which is on one side in the order of rotation speeds, and the ring gear R, which is on the other side in the order of rotation speeds, is drive-coupled to the distribution output member 21 so as to integrally rotate therewith. In the vehicle drive apparatus 1 according to this embodiment, torque in a positive direction of the engine E is transmitted via the input shaft I to the carrier CA, which is in the middle of the order of rotation speeds, and torque in a negative direction outputted by the first rotary electrical machine MG1 is transmitted to the sun gear S, which is on one side in the order of rotation speeds, via the first rotor shaft 31. The torque in the negative direction of the first rotary electrical machine MG1 functions as a reaction force receiver for torque of the engine E. Thus, the planetary gear mechanism PT distributes part of torque of the engine E transmitted to the carrier CA via the input shaft I to the first rotary electrical machine MG1, and distributes the rest to the distribution output member 21.

Here, the carrier CA and the engine E of the planetary gear mechanism PT according to this embodiment are coupled via a damper D. Thus, one side of the input shaft I is coupled to the carrier CA, and the other side is coupled to the engine output shaft Eo of the engine E via the damper D so as to integrally rotate therewith. The damper D is a device to transmit rotation of the engine output shaft Eo of the engine E to the input shaft I while damping torsional vibration of the engine output shaft Eo, and one of various publicly known dampers may be used as this damper.

The distribution output member 21 is formed to be capable of integrally rotate with the ring gear R and the output gear 22. This allows torque transmitted to the distribution output member 21 via the ring gear R of the planetary gear mechanism PT to be outputted to the side of the vehicle wheels W via the output gear 22.

The vehicle drive apparatus 1 according to this embodiment further includes a counter gear mechanism C. The counter gear mechanism C transmits torque outputted from the output gear 22 further to the side of the vehicle wheels W. This counter gear mechanism C is structured to have a counter shaft 41, a first gear 42, and a second gear 43. The first gear 42 meshes with the output gear 22. The first gear 42 also meshes with the second rotary electrical machine output gear 37 at a position in a circumferential direction different from the output gear 22. The second gear 43 meshes with a differential input gear 46 which an output differential gear unit DF has, which output differential gear unit DF will be described later. Therefore, the counter gear mechanism C transmits torque transmitted to the output gear 22 and torque of the second rotary electrical machine MG2 to the output differential gear unit DF.

The vehicle drive apparatus 1 according to this embodiment further includes the output differential gear unit DF. The output differential gear unit DF has a differential input gear 46, and transmits torque transmitted to this differential input gear 46 to a plurality of wheels W in a distributed manner. In this example, the output differential gear unit DF is a differential gear mechanism using a plurality of bevel gears meshing with each other, and splits torque transmitted to the differential input gear 46 via the second gear 43 of the counter gear mechanism C and transmits the split torque to the two, left and right vehicle wheels W via an axle O.

In this vehicle drive apparatus 1, as partially illustrated in FIG. 2, together with the first rotary electrical machine MG1 and the second rotary electrical machine MG2, a gear mechanism is housed in a fluid-tight space, which is formed in the case 2 and in which oil is enclosed. The gear mechanism is structured to include the planetary gear mechanism PT, the distribution output member 21, the output gear 22, the counter gear mechanism C, the output differential gear unit DF, and so on. Thus, the vehicle drive apparatus 1 according to this embodiment is structured as what is called a transaxle, which is housed integrally in the case 2.

1-2. Supply of the Lubricating Fluid Using a Pump

Next, a lubricating fluid supply structure of the planetary gear mechanism PT for distributing motive power will be described. Note that in the following description, for ease of understanding, an axial direction of the ring gear R is designated as an apparatus axial direction, a radial direction of the ring gear R is designated as an apparatus radial direction, and a circumferential direction of the ring gear R is designated as an apparatus circumferential direction for explaining the structure. As illustrated in FIG. 2, the planetary gear mechanism PT for distributing motive power is structured to include the sun gear S, the ring gear R, the carrier CA, and the pinion gears P. A rotation shaft of the sun gear S is coupled and fixed to the first rotor shaft 31. The coupling and fixing are achieved by engaging spline grooves formed in an inner peripheral face of the sun gear S with spline grooves formed in an outer peripheral face of the first rotor shaft 31. One of end faces in the apparatus axial direction of the sun gear S is supported on an end face in the apparatus axial direction of a large-diameter portion I1 of the input shaft I via a thrust bearing 51. Thus, the sun gear S is capable of integrally rotating with the first rotor shaft 31.

The carrier CA is fixed by welding to an outer peripheral portion of the large-diameter portion I1 of the input shaft I. Thus, torque from the input shaft I is inputted to the carrier CA.

The pinion gears P are provided between external teeth of the sun gear S and internal teeth of the ring gear R. The pinion gears P rotate and revolve between the sun gear S and the ring gear R. Accordingly, a pinion bearing PB is provided along the axial direction on an outer periphery of a pinion shaft PA of each pinion gear P. The pinion gears P are supported on pinion shafts PA, respectively, via pinion bearings PB. The pinion shafts PA are coupled and fixed to the above-described carrier CA. The pinion bearings PB are supplied with the lubricating fluid for alleviating frictional heat generated by rotation and revolution of the pinion gears P. For this lubricating fluid, lubricating fluid flowing through a lubricating fluid passage 80 provided inside in the radial direction of the input shaft I is used. A discharge hole 81 discharging the lubricating fluid outward in the radial direction from the lubricating fluid passage 80 is formed in the input shaft I. The discharging fluid discharged via this discharge hole 81 by a centrifugal force flows through a gap between the distribution output member 21 and the input shaft I, and discharged outward in the radial direction after lubricating a thrust bearing 52. Therefore, the discharge hole 81 functions as an inside fluid supply part supplying the lubricating fluid to the planetary gear mechanism PT from the inside in the radial direction.

To supply the lubricating fluid thus discharged from the discharge hole 81 to the pinion bearings PB, a bearing lubricating passage P1 is formed in each pinion shaft PA. To collect the lubricating fluid that flows through the gap between the above-described distribution output member 21 and the input shaft I and a gap in the thrust bearing 52 and is discharged outward in the radial direction, and to allow this fluid flowing to bearing lubricating passages P1, an inward receiver 82 is provided on an end face in the apparatus axial direction (specifically, the other end face in the apparatus axial direction) of the carrier CA. The inward receiver 82 is structured to include an attaching portion 82A, an extending portion 82B, and a receiving portion 82C. The attaching portion 82A is formed of a member in a circular plate shape and is attached to the end face in the apparatus axial direction of the carrier CA. Therefore, the inward receiver 82 is provided on the end face in the apparatus axial direction of the carrier CA. The extending portion 82B is provided to extend in the apparatus circumferential direction coaxially with the carrier CA and is structured to extend inward in the apparatus radial direction from the attaching portion 82A and toward a side away from the carrier CA in the apparatus axial direction. In this embodiment, the extending portion 82B is formed continuously in the circumferential direction with the same cross-sectional shape as one illustrated in FIG. 2, regardless of the position in the circumferential direction. Specifically, the extending portion 82B is structured to have an inclined portion that extends so as to depart, in the apparatus axial direction, from the end face in the apparatus axial direction of the carrier CA to which the attaching portion 82A is attached, as this portion extends inward in the apparatus radial direction. Thus, in this embodiment, the extending portion 82B is formed in a truncated conical shape. The receiving portion 82C is formed by the extending portion 82B and the end face in the apparatus axial direction of the carrier CA. Therefore, the receiving portion 82C is structured to open inward in the apparatus radial direction. Thus, an opening 83 is formed between an edge located inside in the apparatus radial direction of the extending portion 82B and the end face in the apparatus axial direction of the carrier CA. In this embodiment, an end portion located inside in the apparatus radial direction of the inward receiver 82 is structured to further extend inward in the apparatus radial direction from the edge located inside in the apparatus radial direction of the extending portion 82B. Particularly, in FIG. 2, the end portion is illustrated to extend more inward in the apparatus radial direction than the pinion shafts PA. With such a structure, the depth in the apparatus radial direction of the receiving portion 82C can be enlarged, and it becomes possible to increase the amount of the lubricating fluid that can be retained in the receiving portion 82C.

Thus, the inward receiver 82 is structured to include the receiving portion 82C opening inward in the apparatus radial direction. In such an inward receiver 82, the lubricating fluid is supplied to the opening 83 of the receiving portion 82C of this inward receiver 82 from the discharge hole 81 as the above-described inside fluid supply part.

Accordingly, the lubricating fluid which flowed through the gap between the distribution output member 21 and the input shaft I and the gap in the thrust bearing 52 can be collected properly. The collected lubricating fluid flows through the bearing lubricating passages P1 and is supplied from the bearing lubricating passages P1 to the pinion bearings PB. It is thus possible to lubricate the pinion bearings PB properly. The lubricating fluid supplied to the pinion bearings PB thereafter passes through the gap between the carrier CA and the pinion gears P, and so on by a centrifugal force, flows outward in the radial direction of the planetary gear mechanism PT, and reaches the inner peripheral face of the ring gear R. The ring gear R rotates about the apparatus axial direction as a center of rotation, and thus it is possible to supply the lubricating fluid to each of the plurality of pinion gears P disposed along the apparatus radial direction via internal teeth of the ring gear R, and to further supply the lubricating fluid to the sun gear S therefrom. Thus, it is also possible to lubricate the pinion gears P.

Here, the lubricating fluid is supplied to the above-described discharge hole 81 (inside supply part) by the pump 100. This pump 100 is driven by the engine E drive-coupled to the carrier CA. As illustrated in FIG. 2, a rotation transmitting shaft IM is coupled to the input shaft I drive-coupled to the engine E. The pump 100 is drive-coupled to one side (left side in FIG. 2) in the apparatus axial direction of the rotation transmitting shaft IM via a rotation transmitting mechanism (not illustrated). Therefore, the pump 100 is driven by using the engine E as a motive power source. A communication passage IM1 is formed inside in a radial direction of the rotation transmitting shaft IM. A discharge port (not illustrated) of the pump 100 is communicably connected to one end portion in an axial direction of the communication passage IM1, and the lubricating fluid passage 80 formed inside in the radial direction of the input shaft I is communicably connected to the other end portion in the axial direction of the communication passage IM1. Therefore, the lubricating fluid discharged from the pump 100 flows to the discharge hole 81 via the communication passage IM1 and the lubricating oil passage 80. The lubricating fluid which has flowed to the discharge hole 81 is discharged outward in the radial direction of the apparatus according to a centrifugal force generated by rotation of the input shaft I as described above, and is used for lubricating the pinion bearings PB.

1-3. Supply of the Lubricating Fluid from a Fluid Supply Part

As described above, the vehicle drive apparatus 1 according to the present invention is used for driving a hybrid vehicle. In the hybrid vehicle, according to the state of the vehicle, there are the case where the engine E, the first rotary electrical machine MG1, and the second rotary electrical machine MG2 are used as motive power sources, and the case where the second rotary electrical machine MG2 is used as a motive power source. Among them, in the case where the second rotary electrical machine MG2 is used as a motive power source, what is called EV-traveling is performed. When the vehicle breaks down or something similar happens, towed-traveling of the vehicle may be performed. In such a case, the engine E is in a stopped state, but the distribution output member 21 drive-coupled to the wheels W rotates. Thus, in the planetary gear mechanism PT, the sun gear S, the pinion gears P, and the ring gear R rotate in a state that the carrier CA is stopped. On the other hand, the above-described pump 100 stops operating because the engine E is stopped, and thus supply of lubricating fluid to the planetary gear mechanism PT via the discharge hole 81 is stopped. The vehicle drive apparatus 1 is structured to be capable of supplying the lubricating fluid to the planetary gear mechanism PT properly even in such a situation.

The vehicle drive apparatus 1 includes an outward receiver 72, a fluid supply part 60, and the bearing lubricating passages P1. The outward receiver 72 is structured to include an attaching portion 72A, an extending portion 72B, and a receiving portion 72C. The attaching portion 72A is formed of a member in a circular plate shape and is attached to an end face in the apparatus axial direction of the carrier CA. Here, as described above, the inward receiver 82 is attached to the other end face in the apparatus axial direction (right side in FIG. 2) of the carrier CA. The distribution output member 21 is coupled to the other end in the apparatus axial direction of the ring gear R. In other words, the inward receiver 82 is attached to the end face in the apparatus axial direction of the carrier CA on the side of the distribution output member 21. The outward receiver 72 is provided on (attached to) an end face in the apparatus axial direction (one end face in the apparatus axial direction) of the carrier CA, the end face being on the side where the inward receiver 82 is not attached, and also on the side of the ring gear R where the distribution output member 21 is not coupled (that is, the side of the first rotor Ro1). The extending portion 72B is provided to extend in the apparatus circumferential direction coaxially with the carrier CA and is structured to extend outward in the apparatus radial direction from the attaching portion 72A and toward a side away from the carrier CA in the apparatus axial direction. In this embodiment, the extending portion 72B is formed continuously in the circumferential direction with the same cross-sectional shape illustrated as one illustrated in FIG. 2, regardless of the position in the circumferential direction. Specifically, the extending portion 72B is structured to have an inclined portion that extends so as to depart, in the apparatus axial direction, from the end face in the apparatus axial direction of the carrier CA to which the attaching portion 72A is attached, as this portion extends outward in the apparatus radial direction. Thus, in this embodiment, the extending portion 72B is formed in a truncated conical shape. The receiving portion 72C is formed by the extending portion 72B and the end face in the apparatus axial direction of the carrier CA. Therefore, the receiving portion 72C is structured to open outward in the apparatus radial direction. Thus, an opening 73 is formed between an edge located outside in the apparatus radial direction of the extending portion 72B and the end face in the apparatus axial direction of the carrier CA. In this embodiment, an end portion located outside in the apparatus radial direction of the outward receiver 72 is structured to further extend outward in the apparatus radial direction from the edge located outside in the apparatus radial direction of the extending portion 72B. Particularly, in FIG. 2, the end portion is illustrated to extend more outward in the apparatus radial direction than the pinion shafts PA. With such a structure, the depth in the apparatus radial direction of the receiving portion 72C can be enlarged, and it becomes possible to increase the amount of the lubricating fluid that can be retained in the receiving portion 72C.

Thus, the outward receiver 72 is structured to include the receiving portion 72C opening outward in the apparatus radial direction. The outward receiver 72 is provided on the carrier CA so that the opening 73 of the receiving portion 72C does not overlap with the ring gear R in the apparatus axial direction. That is, the outward receiver 72 is attached to the end face in the apparatus axial direction of the carrier CA so that the ring gear R is not located outside in the radial direction of the opening 73.

The fluid supply part 60 supplies the lubricating fluid to the opening 73 of the outward receiver 72. The opening 73 of the outward receiver 72 is a space formed between the edge located outside in the apparatus radial direction of the extending portion 72B of the outward receiver 72 and the end face in the apparatus axial direction of the carrier CA, as described above. The fluid supply part 60 supplies the lubricating fluid toward this space.

The fluid supply part 60 is structured to include a fluid retaining portion 60A and a fluid dropping port 60B. The fluid retaining portion 60A is structured to retain the lubricating fluid picked up by a gear mechanism. The gear mechanism is one which the vehicle drive apparatus 1 has and which is drive-coupled to the planetary gear mechanism PT. More specifically, the lubricating fluid picked up by the differential input gear 46 which the output differential gear unit DF has, and by the first gear 42 and the second gear 43, and so on which the counter gear mechanism C has, flows through a not-illustrated gutter and is retained in the fluid retaining portion 60A.

The fluid dropping port 60B is provided to communicate with the fluid retaining portion 60A, and drops the lubricating fluid from a position overlapping with the opening 73 of the outward receiver 72 in the apparatus axial direction. Overlapping of the fluid dropping port 60B with the opening 73 of the outward receiver 72 in the apparatus axial direction means that the fluid dropping port 60B and the opening 73 are in a state of having, at least partially, portions at the same position with respect to arrangement in the apparatus axial direction. The fluid dropping port 60B is provided at a position overlapping with the opening 73 of the outward receiver 72 in the apparatus radial direction along a horizontal plane. That is, the fluid dropping port 60B is disposed so as to overlap with the opening 73 when seen from a vertically upper side. The fluid dropping port 60B is disposed above the outward receiver 72 in such a state. Therefore, it is possible to supply the lubricating fluid from the fluid supply part 60 to the outward receiver 72. In this embodiment, the fluid dropping port 60B is disposed at a vertically upper position of the axial center of rotation of the ring gear R.

The bearing lubricating passages P1 are provided as routes of the lubricating fluid, which connect the receiving portion 72C of the outward receiver 72 with the pinion bearings PB of the pinion gears P. As described above, the outward receiver 72 is provided on the one end face in the apparatus axial direction of the carrier CA. The inward receiver 82 is also provided on the other end face in the apparatus axial direction of the carrier CA. Therefore, the bearing lubricating passages P1 are routes of the lubricating fluid which connect the receiving portion 72C of the outward receiver 72, the receiving portion 82C of the inward receiver 82, and the pinion bearings PB of the pinion gears P.

The bearing lubricating passages P1 are structured to have a fluid through passage P11 and a fluid communication passage P12. The fluid through passage P11 passes through each of the pinion shafts PA in an axial direction. In this embodiment, this axial direction is the apparatus axial direction. Further, in this embodiment, the receiving portion 72C is provided on one end portions in the apparatus axial direction of the pinion shafts PA, and the receiving portion 82C is provided on the other end portions in the apparatus axial direction of the pinion shafts PA. Therefore, one end in the apparatus axial direction of the fluid through passage P11 communicates with the receiving portion 72C of the outward receiver 72, and the other end in the apparatus axial direction of the fluid through passage P11 communicates with the receiving portion 82C of the inward receiver 82.

The fluid communication passage P12 communicates the fluid through passage P11 with the pinion bearing PB that is provided on the outer peripheral face of a pinion shaft PA. The fluid through passage P11 is, as described above, a fluid passage provided inside in the radial direction of the pinion shaft PA and passing through the pinion shaft PA in the axial direction. The pinion bearing PB is provided outside in the radial direction of the pinion shaft PA. Therefore, the fluid communication passage P12 is formed by a fluid passage provided in the radial direction so as to communicate the inside in the radial direction with the outside in the radial direction. The vehicle drive apparatus 1 is formed to have such a cooling structure, and supplies the lubricating fluid from the fluid supply part 60 to the pinion gears P and the pinion bearings PB.

Next, flows of the lubricating fluid supplied from the fluid supply part 60 will be described. In the fluid supply part 60, the lubricating fluid picked up by the gear mechanism drive-coupled to the planetary gear mechanism PT is retained. From the fluid dropping port 60B, the lubricating fluid retained in the fluid supply part 60 is dropped. Here, below the fluid dropping port 60B, the opening 73 is fanned by the outward receiver 72 and the one end face in the apparatus axial direction of the planetary gear mechanism PT. Therefore, the lubricating fluid dropped from the fluid dropping port 60B to the opening 73 is collected in the receiving portion 72C.

In the receiving portion 72C, the fluid through passages P11 passing through the pinion shafts PA in the axial direction (apparatus axial direction) are provided to communicate therewith. Therefore, the lubricating fluid collected in the receiving portion 72C flows into the fluid through passages P11. On the other hand, in the fluid through passages P11, the fluid communication passages P12 communicating the fluid through passages P11 with the pinion bearings PB are provided. Therefore, the lubricating fluid flowing into the fluid through passages P11 passes through the fluid communication passages P12 and is supplied to the pinion bearings PB.

Here, the fluid through passages P11 are provided to pass through the pinion shafts PA in the axial direction. On the other end faces in the apparatus axial direction of the pinion shafts PA, the inward receiver 82 is provided. Therefore, most of the lubricating fluid which is collected in the receiving portion 72C and flows through the fluid through passages P11 as described above flows through the fluid communication passages P12, but partially flows to the receiving portion 82C formed by the inward receiver 82 and the other end face in the apparatus axial direction of the planetary gear mechanism PT. This receiving portion 82C is provided inward in the apparatus radial direction as described above. On the other hand, the extending portion 82B of the inward receiver 82 is provided coaxially with the carrier CA to extend in the apparatus circumferential direction. Therefore, the lubricating fluid which have flowed from the fluid through passages P11 to the receiving portion 82C runs down the extending portion 82B and flows downward (gravitationally downward). On the other hand, the planetary gear mechanism PT is structured to include the plurality of pinion gears P, and the inward receiver 82 is provided to communicate also with the fluid through passages P11 of the pinion shafts PA which the respective pinion gears P have. Therefore, the lubricating fluid which have run down the extending portion 82B and flowed downward can flow through the fluid through passages 11 of the respective pinion shafts PA in the process of flowing downward.

Here, as described above, during EV traveling or towed traveling, the pinion gears P just rotates and the ring gear R rotates since the carrier CA is stopped. Therefore, the lubricating fluid which have flowed through the fluid communication passages P12 and have been supplied to the pinion bearings PB can be supplied to the plurality of pinion gears P provided in the apparatus circumferential direction and the sun gear S via the ring gear R.

In this manner, the vehicle drive apparatus 1 retains the lubricating fluid, which is picked up by the gear mechanism drive-coupled to the planetary gear mechanism PT, in the fluid supply part 60 provided above the planetary gear mechanism PT, and uses the lubricating fluid retained in this manner to lubricate the pinion gears P and the pinion bearings PB. Therefore, it is possible to supply the lubricating fluid to the pinion bearings PB provided respectively on the outer peripheral faces of the plurality of pinion bearings PA even when the engine E is in a stopped state.

When the engine E is in a stopped state, the carrier CA does not rotate, and thus the outward receiver 72 attached on the end face in the apparatus axial direction of the carrier CA does not rotate either. Accordingly, the centrifugal force does not act on the lubricating fluid supplied to the receiving portion 72C of the outward receiver 72 from the fluid supply part 60. Therefore, the lubricating fluid would not be discharged outward in the apparatus radial direction from the receiving portion 72C.

As has been described, in the vehicle drive apparatus 1, the opening 73 of the receiving portion 72C of the outward receiver 72 is provided to open outward in the radial direction of the ring gear R, and the receiving portion 72C having this opening 73 and the pinion bearings PB of the pinion gears P are provided to be connected by the bearing lubricating passages P1. Thus, the lubricating fluid from the fluid supply part 60 can be supplied to the pinion bearings PB. Accordingly, it is possible to supply the lubricating fluid to the pinion bearings PB regardless of the operating states of the first rotary electrical machine MG1 and the engine E which are drive-coupled to the planetary gear mechanism PT. Therefore, even when the engine E is in a stopped state, the pinion bearings PB can be lubricated properly.

2. Second Embodiment

In the description of the first embodiment, the outward receiver 72 includes an attaching portion 72A, an extending portion 72B, and a receiving portion 72C, and the bearing lubricating passages P1 are structured to have a fluid through passage P11 and a fluid communication passage P12. This embodiment is different from the first embodiment in that the outward receiver 72 includes an outer peripheral groove 72D and communication holes 72E, and the bearing lubricating passages P1 are structured to have a fluid communication passage P12, a first bearing lubricating passage P17, and a second bearing lubricating passage P18. Besides the outward receiver 72 and the bearing lubricating passages P1, this embodiment has the same structure as the first embodiment, and thus the outward receiver 72 and the bearing lubricating passages P1 will be described below.

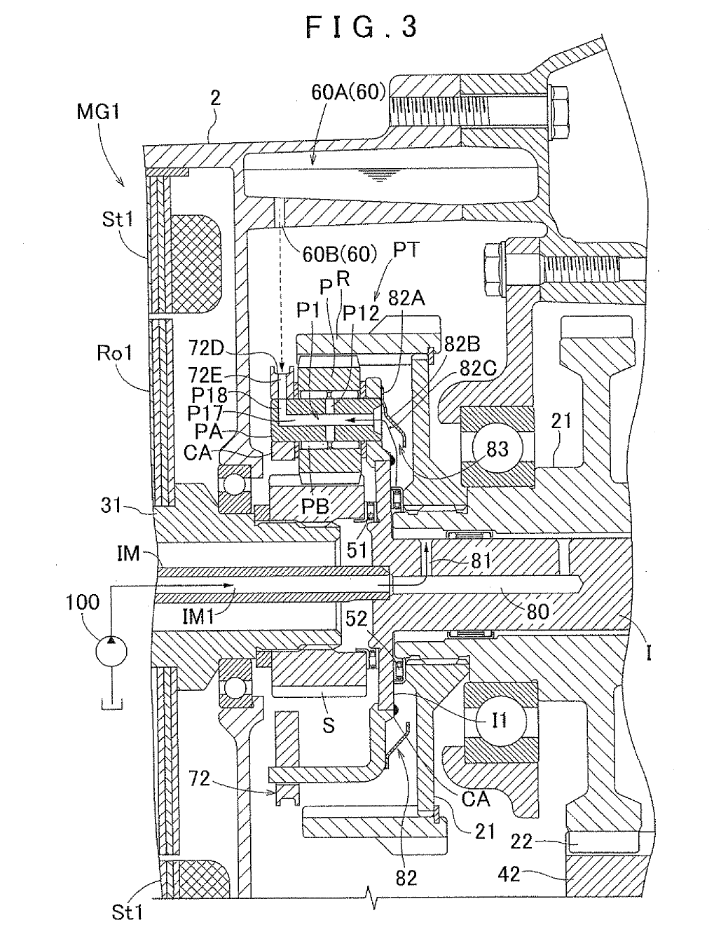

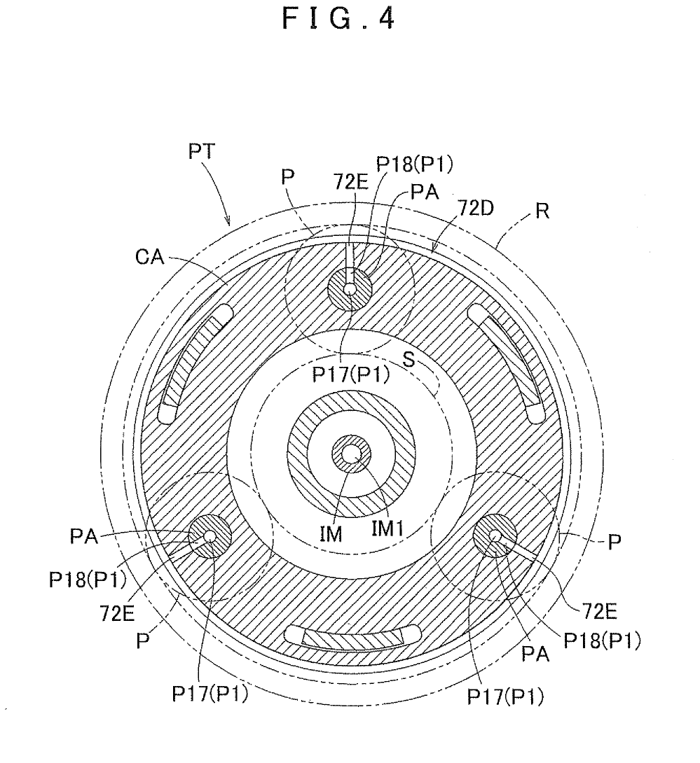

FIG. 3 illustrates a cross-sectional view of a substantial part of a vehicle drive apparatus 1 according to this embodiment. FIG. 4 illustrates a front view in the apparatus axial direction of a carrier CA according to this embodiment. In this embodiment, there is described an example in which, as illustrated in FIG. 4, three pinion shafts PA are provided along the apparatus circumferential direction, and the pinion shafts PA are disposed respectively at 120-degree positions with a center part in the apparatus radial direction being the point of origin. Accordingly, FIG. 3 illustrates a cross-sectional view taken along a line connecting the axial center of one pinion shaft PA with the axial center of a rotation transmitting shaft IM, and illustrates only one pinion shaft PA.

Referring back to FIG. 3, the outward receiver 72 according to this embodiment is structured to include an outer peripheral groove 72D and communication holes 72E as described above. The outer peripheral groove 72D is provided in an outer peripheral face of the carrier CA and opens outward in the apparatus radial direction. In this embodiment, the outer peripheral groove 72D has a certain width and depth, and is provided across the entire circumference of the outer peripheral face of the carrier CA, as illustrated in FIG. 3 and FIG. 4. Such an outer peripheral groove 72D corresponds to the receiving portion 72C according to the present invention and the first embodiment, and an opening part of the outer peripheral groove 72D corresponds to the opening 73 according to the present invention and the first embodiment. Also in this embodiment, the lubricating fluid is dropped from the fluid dropping port 60B overlapping in the apparatus axial direction with the opening 73 of the outward receiver 72, that is, the opening part of the outer peripheral groove 72D. Therefore, it is possible to collect the lubricating fluid dropped from the fluid dropping port 60B properly with the outer peripheral groove 72D.

The communication holes 72E communicate the outer peripheral groove 72D with the bearing lubricating passages P1. The outer peripheral groove 72D corresponds to the receiving portion 72C of the outward receiver 72 as described above, and collects the lubricating fluid. The bearing lubricating passages P1 are routes of the lubricating fluid connecting the outer peripheral groove 72D corresponding to the receiving portion 72C of the outward receiver 72 with the pinion bearings PB of the pinion gears P. In this embodiment, the communication holes 72E are provided between the outer peripheral groove 72D and the bearing lubricating passages P1. The communication holes 72E are provided at positions corresponding to the second bearing lubricating passages P18 of the bearing lubricating passages P1 in the carrier CA, and provided at three positions as illustrated in FIG. 4 in this embodiment. The communication holes 72E are provided on extension lines of the second bearing lubricating passages P18, which will be described later.

Here, the bearing lubricating passages P1 according to this embodiment are each structured from a first bearing lubricating passage P17 formed along the axial center of the pinion shaft PA, and a second bearing lubricating passage P18 formed outward in the apparatus radial direction from an end portion in the axial direction of this first bearing lubricating passage P17. In a center portion in the axial direction of the first bearing lubricating passage P17, similarly to the above-described first embodiment, a fluid communication passage P12 is provided. Thus, the first bearing lubricating passage P17 is communicated with the pinion bearing PB provided on the outer peripheral face of the pinion shaft PA, allowing the lubricating fluid collected in the outer peripheral groove 72D to be supplied to the pinion bearing PB via the communication hole 72E and the bearing lubricating passage P1. Therefore, the lubricating fluid dropped from the fluid dropping port 60B can be used to lubricate the pinion bearings PB.

3. Third Embodiment

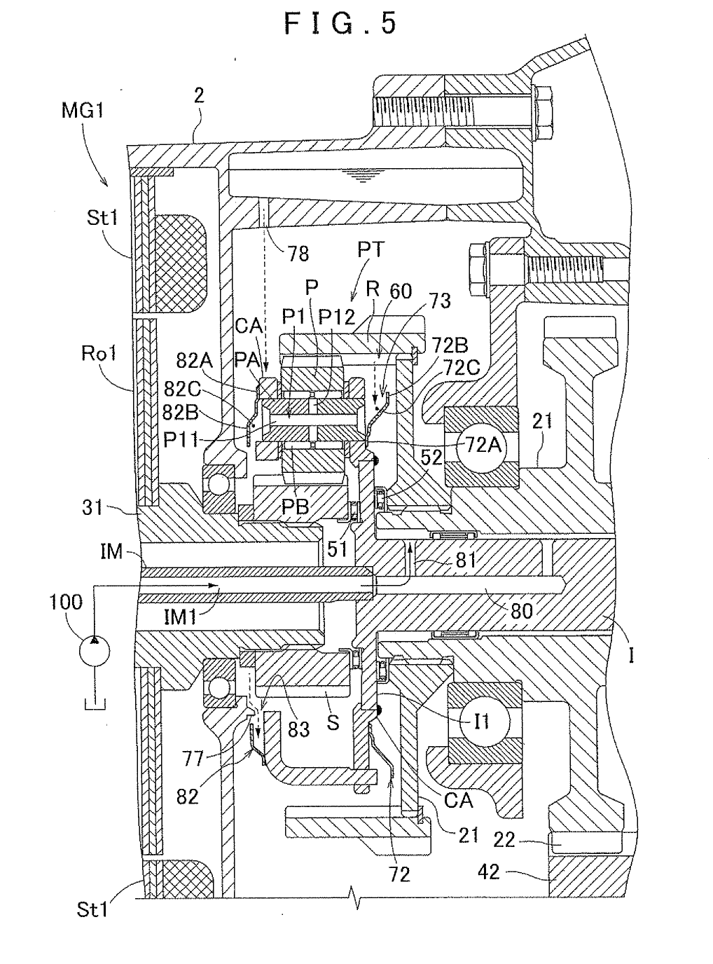

In the description of the first embodiment, the outward receiver 72 is attached to the end face in the apparatus axial direction of the carrier CA on the side of the first rotor Ro1, and the inward receiver 82 is attached to the end face in the apparatus axial direction of the carrier CA on the side of the distribution output member 21. This embodiment is different from the first embodiment in that the outward receiver 72 is attached to the end face in the apparatus axial direction of the carrier CA on the side of the distribution output member 21, and the inward receiver 82 is attached to the end face in the apparatus axial direction of the carrier CA on the side of the first rotor Ro1. That is, in this example, the right side in FIG. 5 corresponds to “one side in the apparatus axial direction”, and the left side in FIG. 5 corresponds to “the other side in the apparatus axial direction”. Hereinafter, a vehicle drive apparatus 1 structured thus will be described.

FIG. 5 illustrates a cross-sectional view of a substantial part of the vehicle drive apparatus 1 according to this embodiment. Also in this embodiment, there is described an example in which three pinion shafts PA are provided along the apparatus circumferential direction, and the pinion shafts PA are disposed respectively at 120-degree positions with a center part in the apparatus radial direction being the point of origin. Accordingly, FIG. 5 illustrates a cross-sectional view taken along a line connecting the axial center of one pinion shaft PA with the axial center of a rotation transmitting shaft IM, and illustrates only one pinion shaft PA.

The outward receiver 72 according to this embodiment is structured to include, similarly to the first embodiment, an attaching portion 72A, an extending portion 72B, and a receiving portion 72C. The attaching portion 72A is formed of a circular plate member and is attached to an end face in the apparatus axial direction of the carrier CA on the side of the distribution output member 21 of the carrier CA. The extending portion 72B is provided to extend in the apparatus circumferential direction coaxially with the carrier CA and is structured to extend outward in the apparatus radial direction from the attaching portion 72A and toward a side to depart from the carrier CA in the apparatus axial direction. The receiving portion 72C is formed by the extending portion 72B and the end face in the apparatus axial direction of the carrier CA. Therefore, the receiving portion 72C is structured to open outward in the apparatus radial direction. Thus, an opening 73 is formed between an edge located outside in the apparatus radial direction of the extending portion 72B and the end face in the apparatus axial direction of the carrier CA. With such a structure, it is possible to retain the lubricating fluid in the receiving portion 72C.

Thus, the outward receiver 72 is structured to include the receiving portion 72C opening outward in the apparatus radial direction. In this embodiment, the outward receiver 72 is provided on the carrier CA so that the opening 73 of this receiving portion 72C overlaps with the ring gear R in the apparatus axial direction. That is, the outward receiver 72 is attached to the end face in the apparatus axial direction of the carrier CA so that the ring gear R is located outside in the radial direction of the opening 73.

In this embodiment, a fluid supply part 60 is structured to include internal teeth of the ring gear R. For example, the lubricating fluid, which is discharged from a discharge hole 81 forming the fluid supply part 60 together with the internal teeth of the ring gear R, flows through a gap between the distribution output member 21 and the input shaft I and a gap in the thrust bearing 52, and is discharged outward in the radial direction, can be picked upward by the internal teeth of the ring gear R according to rotation of the ring gear R. Thus, the lubricating fluid which is picked up and then drops can be collected with the receiving portion 72C of the outward receiver 72 and supplied to the pinion bearings PB via the bearing lubricating passages P1. Therefore, the lubricating fluid picked up by the internal teeth of the ring gear R can be used to lubricate the pinion bearings PB. The fluid supply part 60 according to this embodiment is not limited to the internal teeth of the ring gear R, and includes the planetary gear mechanism PT and so on for example. Accordingly, it is also possible of course to pick up the lubricating fluid with respective parts of the planetary gear mechanism PT to supply the lubricating fluid in the receiving portion 72C of the outward receiver 72.

In this embodiment, similarly to the first embodiment, the inward receiver 82 is structured to include an attaching portion 82A, an extending portion 82B, and a receiving portion 82C. The attaching portion 82A is formed of a member in a circular plate shape and is attached to the end face in the apparatus axial direction of the carrier CA on the side of the first rotor Ro1. The extending portion 82B is provided to extend in the apparatus circumferential direction coaxially with the carrier CA and is structured to extend inward in the apparatus radial direction from the attaching portion 82A and extend toward a side away from the carrier CA in the apparatus axial direction. The receiving portion 82C is formed by the extending portion 82B and the end face in the apparatus axial direction of the carrier CA. Therefore, the receiving portion 82C is structured to open inward in the apparatus radial direction. Thus, an opening 83 is formed between an edge located inside in the apparatus radial direction of the extending portion 82B and the end face in the apparatus axial direction of the carrier CA. With such a structure, it is possible to retain the lubricating fluid in the receiving portion 82C.

Thus, the inward receiver 82 is structured to include the receiving portion 82C opening inward in the apparatus radial direction. In this embodiment, a flange portion 77 is provided to allow the lubricating fluid dropped from the fluid dropping port 78 to flow properly to such an inward receiver 82. The flange portion 77 is provided to project on the side of the planetary gear mechanism PT from the case 2, so as to overlap in the apparatus axial direction with the opening 83 of the inward receiver 82. Further, the flange portion 77 is provided lower than at least the first rotor shaft 31 and provided more inside in the apparatus radial direction than the inward receiver 82. With such a structure, the flange portion 77 restricts the flowing route of the lubricating fluid which is dropped from the fluid dropping port 78 and flows along a wall face of the case 2, a coupling part of the sun gear S drive-coupled to the first rotor shaft 31, and so on, and thereby the lubricating fluid can be supplied to the opening part 83 of the receiving portion 82C of the inward receiver 82.

Thus, the vehicle drive apparatus 1 according to this embodiment is able to properly collect the lubricating fluid from the fluid dropping port 78. The collected lubricating fluid flows through the bearing lubricating passages P1 and is supplied from the bearing lubricating passages P1 to the pinion bearings PB, and thereby the pinion bearings PB can be lubricated properly. The lubricating fluid supplied to the pinion bearings PB thereafter passes through the gap between the carrier CA and the pinion gears P, and so on by a centrifugal force, flows outward in the radial direction of the planetary gear mechanism PT, and reaches the inner peripheral face of the ring gear R. The ring gear R rotates about the apparatus axial direction as a center of rotation, and thus it is possible to supply the lubricating fluid to each of the plurality of pinion gears P disposed along the apparatus radial direction via internal teeth of the ring gear R, and further supply the lubricating fluid to the sun gear S therefrom. Thus, it is also possible to lubricate the pinion gears P.

4. Fourth Embodiment

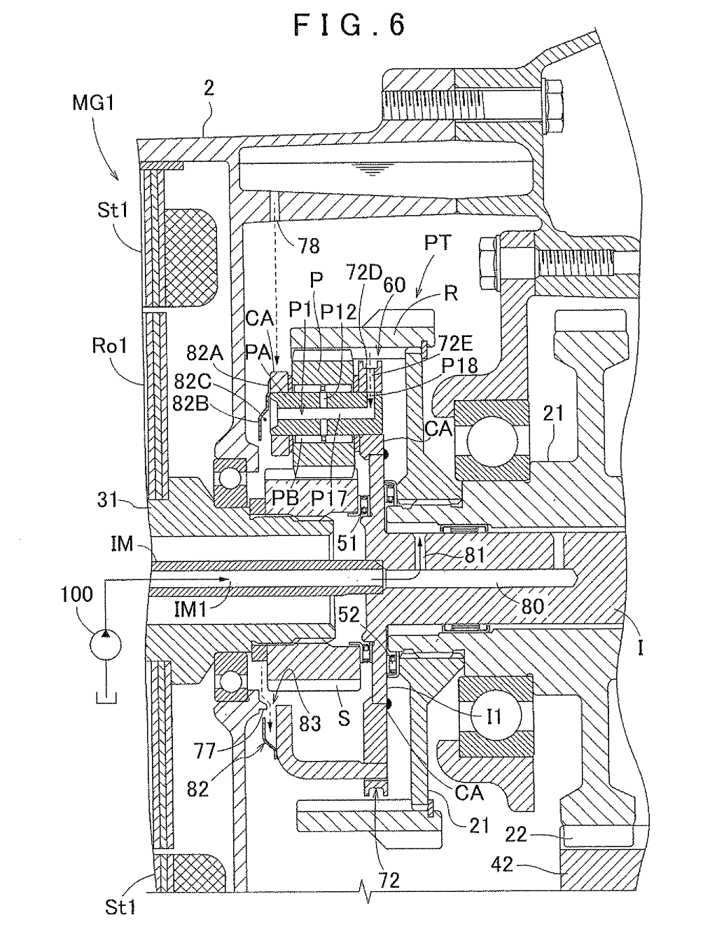

In a vehicle drive apparatus 1 according to this embodiment, similarly to the second embodiment, the outward receiver 72 includes an outer peripheral groove 72D and communication holes 72E, and the bearing lubricating passages P1 are structured to include a first bearing lubricating passage P17 and a second bearing lubricating passage P18. Similarly to the third embodiment, the outward receiver 72 is attached to the end face in the apparatus axial direction of the carrier CA on the side of the distribution output member 21, and the inward receiver 82 is attached to the end face in the apparatus axial direction of the carrier CA on the side of the first rotor Ro1. A cross-sectional view of a substantial part of the vehicle drive apparatus 1 according to such an embodiment is illustrated in FIG. 6. Also in this embodiment, there is described an example in which three pinion shafts PA are provided along the apparatus circumferential direction, and the pinion shafts PA are disposed respectively at 120-degree positions with a center part in the apparatus radial direction being the point of origin. Accordingly, FIG. 6 illustrates a cross-sectional view taken along a line connecting the axial center of one pinion shaft PA with the axial center of a rotation transmitting shaft IM, and shows only one pinion shaft PA. The functions of the respective components are the same as those in the second embodiment and the third embodiment described above, and thus are omitted from the description. With the structure described in FIG. 6, similarly to the second embodiment, it is possible of course to pick up the lubricating fluid with the internal teeth of the ring gear R and supply the picked up lubricating fluid to the pinion bearings PB, so as to lubricate the pinion bearings PB.

[Other Embodiments]

(1) In the above-described embodiments, the distribution output member 21 is drive-coupled to the ring gear R, and the first rotor shaft 31 of the first rotary electrical machine MG1 is drive-coupled to the sun gear S. However, the applicable range of the present invention is not limited to this. For example, it is possible of course that the first rotor shaft 31 of the rotary electrical machine MG1 is drive-coupled to the ring gear R, and the distribution output member 21 is drive-coupled to the sun gear S. Also in this case, it is possible of course that the lubricating fluid from the fluid supply part 60 is supplied to the opening 73 of the receiving portion 72C of the outward receiver 72, so as to lubricate the pinion bearings PB.

(2) In the first embodiment and the second embodiment described above, the fluid supply part 60 supplies the lubricating fluid picked up by the gear mechanism drive-coupled to the planetary gear mechanism PT to the outward receiver 72. However, the applicable range of the present invention is not limited to this. It is also possible of course to employ a structure in which the fluid supply part 60 supplies lubricating fluid discharged from, for example, a pump driven by a member drive-coupled to the vehicle wheels W such as the distribution output member 21 to the outward receiver 72. Also in this case, it is possible of course to supply the lubricating fluid to the pinion bearings PB when the engine E is in a stopped state.

(3) In the first embodiment and the second embodiment described above, the fluid supply part 60 has a fluid retaining portion 60A retaining the lubricating fluid picked up by the gear mechanism, and a fluid dropping port 60B communicating with the fluid retaining portion 60A and dropping the lubricating fluid from a position that overlaps with the opening 73 of the outward receiver 72 in the apparatus axial direction. However, the applicable range of the present invention is not limited to this. For example, it is also possible that the lubricating fluid is retained in the fluid retaining portion 60A using a pump driven by a member drive-coupled to the vehicle wheels W such as the distribution output member 21. Also in this case, it is possible of course to supply the lubricating fluid to the pinion bearings PB when the engine E is in a stopped state.

(4) In the above-described embodiments, the outward receiver 72 is provided to extend in the apparatus circumferential direction coaxially with the carrier CA. However, the applicable range of the present invention is not limited to this. In another preferred embodiment of the present invention, a plurality of outward receivers 72 corresponding respectively to the plurality of pinion shafts PA are provided. In this case, it is also possible to employ a structure in which, for example, there are provided outward receivers 72 each formed of a recessed portion opening outward in the radial direction so as to communicate the respective bearing lubricating passages P1, on the end face on one side in the axial direction of the pinion shafts PA. In such a case, it is preferred that the width of the fluid dropping port 60B in a horizontal direction within an axially perpendicular plane match or substantially match the width of the planetary gear mechanism PT in the apparatus radial direction. With such a structure, it is possible to supply the lubricating fluid from the fluid supply part 60 to the openings 73 of the outward receivers 72 which are located on an upper side in a view in the apparatus axial direction, and the lubricating fluid can be supplied to the pinion bearings PB.

(5) In the above-described embodiments, the outward receiver 72 is provided on the one end face in the apparatus axial direction of the carrier CA, and the inward receiver 82 is provided on the other end face in the apparatus axial direction of the carrier CA. However, the applicable range of the present invention is not limited to this. It is possible of course to employ a structure including only the outward receiver 72, and not including the inward receiver 82. Also in such a structure, it is possible of course to supply the lubricating fluid to the pinion bearings PB regardless of the operating state of the engine E.

(6) In the first embodiment and the third embodiment described above, the bearing lubricating passages P1 are each structured to have a fluid through passage P11 passing through a pinion shaft PA in the axial direction, and a fluid communication passage P12 communicating the fluid through passage P11 with a pinion bearing PB provided on an outer peripheral face of the pinion shaft PA. However, the applicable range of the present invention is not limited to this. It is possible of course to employ a structure in which the fluid through passage P11 does not pass through the pinion shaft PA in the axial direction. For example, when the inward receiver 82 is not provided, it is possible to employ a form such that the fluid through passage P11 ends at a middle point in the axial direction of the pinion shaft PA, and communicates with the fluid communication passage P12 from this middle position in the axial direction. Alternatively, when the inward receiver 82 is provided, a fluid passage for the outward receiver 72 and a fluid passage for the inward receiver 82 may be provided independently. Preferably, for example, a first fluid passage ending at a middle point in the axial direction of the pinion shaft PA is provided so as to communicate with the receiving portion 72C, and a second fluid passage is provided from this first fluid passage toward one of an outside in the apparatus radial direction and an inside in the apparatus radial direction. Also preferably, a third fluid passage ending at a middle point in the axial direction of the pinion shaft PA is provided so as to communicate with the receiving portion 82C but not to be communicably connected with the first fluid passage, and a fourth fluid passage is provided from this third fluid passage toward the other of the outside in the apparatus radial direction and the inside in the apparatus radial direction. In such a structure, it is possible of course to properly lubricate the pinion bearings PB. In the second embodiment and the fourth embodiment described above, similarly, it is possible of course to employ a structure in which the first bearing lubricating passage P17 which each bearing lubricating passage P1 has does not reach the side of the inward receiver 82.

(7) In the above-described embodiments, the end portion located inside in the apparatus radial direction of the inward receiver 82 extends more inward in the apparatus radial direction than the pinion shafts PA, and the end portion located outside in the apparatus radial direction of the outward receiver 72 extends more outward in the apparatus radial direction than the pinion shafts PA. However, the applicable range of the present invention is not limited to this. The lengths in the radial direction of the inward receiver 82 and the outward receiver 72 may be shortened. Alternatively, it is also possible to employ a structure in which the end portion located inside in the apparatus radial direction of the inward receiver 82 matches the edge located inside in the apparatus radial direction of the extending portion 82B, and the end portion located outside in the apparatus radial direction of the outward receiver 72 matches the edge located outside in the apparatus radial direction of the extending portion 72B. Also in such a structure, the lubricating fluid can be supplied to the pinion bearings PB.

(8) In the second embodiment and the fourth embodiment described above, the outer peripheral groove 72D of the outward receiver 72 is provided across the entire circumference of the outer peripheral face of the carrier CA. However, the applicable range of the present invention is not limited to this. It is possible of course that the outer peripheral groove 72D is provided partially in the outer peripheral face of the carrier CA. In this case, there may be provided a plurality of outer peripheral grooves 72D each having a predetermined length along the apparatus circumferential direction and being centered at a communication hole 72E.

(9) In the second embodiment, the third embodiment, and the fourth embodiment described above, there is described an example in which three pinion shafts PA are provided along the apparatus circumferential direction, and the pinion shafts PA are disposed respectively at 120-degree positions. However, the applicable range of the present invention is not limited to this. It is also possible of course to employ a structure including four or more pinion shafts PA.

The present invention is applicable to a vehicle drive apparatus including a planetary gear mechanism having a ring gear drive-coupled to one of an output member drive-coupled to wheels and a rotary electrical machine, a sun gear drive-coupled to the other of the output member and the rotary electrical machine, and a carrier drive-coupled to an engine and rotatably supporting a plurality of pinion gears.

What is claimed is:

1. A vehicle drive apparatus comprising a planetary gear mechanism having a ring gear drive-coupled to one of an output member drive-coupled to wheels and a rotary electrical machine, a sun gear drive-coupled to the other of the output member and the rotary electrical machine, and a carrier drive-coupled to an engine and rotatably supporting a plurality of pinion gears, the apparatus comprising:
an outward receiver comprising a receiving portion opening outward in an apparatus radial direction and being provided on the carrier, the apparatus radial direction being a radial direction of the ring gear;
a fluid supply part supplying lubricating fluid to an opening of the receiving portion of the outward receiver; and
a bearing lubricating passage which is a route of lubricating fluid connecting the receiving portion of the outward receiver with a pinion bearing of each of the pinion gears.

2. The vehicle drive apparatus according to claim 1, wherein
the outward receiver is provided so that the opening does not overlap with the ring gear in an apparatus axial direction, the apparatus axial direction being an axial direction of the ring gear; and
the fluid supply part is provided to supply the lubricating fluid toward the opening of the outward receiver.

3. The vehicle drive apparatus according to claim 1, wherein
the fluid supply part supplies lubricating fluid picked up by a gear mechanism drive-coupled to the planetary gear mechanism to the outward receiver.

4. The vehicle drive apparatus according to claim 3, wherein
the fluid supply part has a fluid retaining portion retaining the lubricating fluid picked up by the gear mechanism, and a fluid dropping port communicating with the fluid retaining portion and dropping the lubricating fluid from a position overlapping with the opening of the outward receiver in an apparatus axial direction, the apparatus axial direction being an axial direction of the ring gear.

5. The vehicle drive apparatus according to claim 1, wherein
the fluid supply part includes internal teeth of the ring gear overlapping with the opening of the outward receiver in an apparatus axial direction, the apparatus axial direction being an axial direction of the ring gear.

6. The vehicle drive apparatus according to claim 1, wherein
the outward receiver comprises an attaching portion attached to an end face in an apparatus axial direction of the carrier, the apparatus axial direction being an axial direction of the ring gear, and an extending portion provided to extend in an apparatus circumferential direction coaxially with the carrier, the apparatus circumferential direction being a circumferential direction of the ring gear, and extend outward in the apparatus radial direction from the attaching portion and toward a side to depart from the carrier in the apparatus axial direction; and
the receiving portion is formed of the extending portion and the end face in the apparatus axial direction of the carrier, and the opening is formed between an edge located outside in the apparatus radial direction of the extending portion and the end face in the apparatus axial direction of the carrier.

7. The vehicle drive apparatus according to claim 1, wherein
the outward receiver comprises an outer peripheral groove as the receiving portion provided in an outer peripheral face of the carrier and opening outward in the apparatus radial direction, and a communication hole communicating the outer peripheral groove with the bearing lubricating passage.

8. The vehicle drive apparatus according to claim 1, wherein
the outward receiver is provided on one end face in an apparatus axial direction of the carrier, the apparatus axial direction being an axial direction of the ring gear;
the vehicle drive apparatus comprises an inward receiver comprising a receiving portion opening inward in the apparatus radial direction and being provided on another end face in the apparatus axial direction of the carrier, and an inside fluid supply part supplying lubricating fluid to an opening of the receiving portion of the inward receiver; and
the bearing lubricating passage also has a route of lubricating fluid connecting the receiving portion of the inward receiver with a pinion bearing of each of the pinion gears.

9. The vehicle drive apparatus according to claim 8, wherein
the carrier comprises a pinion shaft supporting each of the pinion gears via the pinion bearing;
the bearing lubricating passage is structured to have a fluid through passage passing through the pinion shaft in an axial direction, and a fluid communication passage communicating the fluid through passage with the pinion bearing provided on an outer peripheral face of the pinion shaft; and
one end in the apparatus axial direction of the fluid through passage communicates with the receiving portion of the outward receiver, and another end in the apparatus axial direction of the fluid through passage communicates with the receiving portion of the inward receiver.

10. The vehicle drive apparatus according to claim 8, further comprising:
a pump driven by the engine drive-coupled to the carrier to supply lubricating fluid to the inside fluid supply part.

11. The vehicle drive apparatus according to claim 2, wherein
the fluid supply part supplies lubricating fluid picked up by a gear mechanism drive-coupled to the planetary gear mechanism to the outward receiver.

12. The vehicle drive apparatus according to claim 11, wherein
the fluid supply part has a fluid retaining portion retaining the lubricating fluid picked up by the gear mechanism, and a fluid dropping port communicating with the fluid retaining portion and dropping the lubricating fluid from a position overlapping with the opening of the outward receiver in an apparatus axial direction, the apparatus axial direction being an axial direction of the ring gear.

13. The vehicle drive apparatus according to claim 12, wherein
the outward receiver comprises an attaching portion attached to an end face in an apparatus axial direction of the carrier, the apparatus axial direction being an axial direction of the ring gear, and an extending portion provided to extend in an apparatus circumferential direction coaxially with the carrier, the apparatus circumferential direction being a circumferential direction of the ring gear, and extend outward in the apparatus radial direction from the attaching portion and toward a side to depart from the carrier in the apparatus axial direction; and
the receiving portion is formed of the extending portion and the end face in the apparatus axial direction of the carrier, and the opening is formed between an edge located outside in the apparatus radial direction of the extending portion and the end face in the apparatus axial direction of the carrier.

14. The vehicle drive apparatus according to claim 13, wherein
the outward receiver comprises an outer peripheral groove as the receiving portion provided in an outer peripheral face of the carrier and opening outward in the apparatus radial direction, and a communication hole communicating the outer peripheral groove with the bearing lubricating passage.

15. The vehicle drive apparatus according to claim 14, wherein
the outward receiver is provided on one end face in an apparatus axial direction of the carrier, the apparatus axial direction being an axial direction of the ring gear;
the vehicle drive apparatus comprises an inward receiver comprising a receiving portion opening inward in the apparatus radial direction and being provided on another end face in the apparatus axial direction of the carrier, and an inside fluid supply part supplying lubricating fluid to an opening of the receiving portion of the inward receiver; and
the bearing lubricating passage also has a route of lubricating fluid connecting the receiving portion of the inward receiver with a pinion bearing of each of the pinion gears.

16. The vehicle drive apparatus according to claim 15, wherein
the carrier comprises a pinion shaft supporting each of the pinion gears via the pinion bearing;
the bearing lubricating passage is structured to have a fluid through passage passing through the pinion shaft in an axial direction, and a fluid communication passage communicating the fluid through passage with the pinion bearing provided on an outer peripheral face of the pinion shaft; and
one end in the apparatus axial direction of the fluid through passage communicates with the receiving portion of the outward receiver, and another end in the apparatus axial direction of the fluid through passage communicates with the receiving portion of the inward receiver.

17. The vehicle drive apparatus according to claim 16, further comprising:
a pump driven by the engine drive-coupled to the carrier to supply lubricating fluid to the inside fluid supply part.

18. The vehicle drive apparatus according to claim 2, wherein
the outward receiver comprises an attaching portion attached to an end face in an apparatus axial direction of the carrier, the apparatus axial direction being an axial direction of the ring gear, and an extending portion provided to extend in an apparatus circumferential direction coaxially with the carrier, the apparatus circumferential direction being a circumferential direction of the ring gear, and extend outward in the apparatus radial direction from the attaching portion and toward a side to depart from the carrier in the apparatus axial direction; and
the receiving portion is formed of the extending portion and the end face in the apparatus axial direction of the carrier, and the opening is formed between an edge located outside in the apparatus radial direction of the extending portion and the end face in the apparatus axial direction of the carrier.

19. The vehicle drive apparatus according to claim 3, wherein
the outward receiver comprises an attaching portion attached to an end face in an apparatus axial direction of the carrier, the apparatus axial direction being an axial direction of the ring gear, and an extending portion provided to extend in an apparatus circumferential direction coaxially with the carrier, the apparatus circumferential direction being a circumferential direction of the ring gear, and extend outward in the apparatus radial direction from the attaching portion and toward a side to depart from the carrier in the apparatus axial direction; and
the receiving portion is formed of the extending portion and the end face in the apparatus axial direction of the carrier, and the opening is formed between an edge located outside in the apparatus radial direction of the extending portion and the end face in the apparatus axial direction of the carrier.

20. The vehicle drive apparatus according to claim 4, wherein
the outward receiver comprises an attaching portion attached to an end face in an apparatus axial direction of the carrier, the apparatus axial direction being an axial direction of the ring gear, and an extending portion provided to extend in an apparatus circumferential direction coaxially with the carrier, the apparatus circumferential direction being a circumferential direction of the ring gear, and extend outward in the apparatus radial direction from the attaching portion and toward a side to depart from the carrier in the apparatus axial direction; and
the receiving portion is formed of the extending portion and the end face in the apparatus axial direction of the carrier, and the opening is formed between an edge located outside in the apparatus radial direction of the extending portion and the end face in the apparatus axial direction of the carrier.

21. The vehicle drive apparatus according to claim 5, wherein
the outward receiver comprises an attaching portion attached to an end face in an apparatus axial direction of the carrier, the apparatus axial direction being an axial direction of the ring gear, and an extending portion provided to extend in an apparatus circumferential direction coaxially with the carrier, the apparatus circumferential direction being a circumferential direction of the ring gear, and extend outward in the apparatus radial direction from the attaching portion and toward a side to depart from the carrier in the apparatus axial direction; and
the receiving portion is formed of the extending portion and the end face in the apparatus axial direction of the carrier, and the opening is formed between an edge located outside in the apparatus radial direction of the extending portion and the end face in the apparatus axial direction of the carrier.
